(19) United States
(12) Patent Application Publication
(10) Pub. No.: US 2007/0052782 A1
(43) Pub. Date: Mar. 8, 2007

(54) Ink circulation device having degassing function

(75) Inventor: Jae-cheol Lee, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/483,853

(22) Filed: Jul. 11, 2006

(30) Foreign Application Priority Data
Sep. 5, 2005 (KR) 2005-82436

(51) Int. Cl. B41J 2/17

(52) U.S. Cl. 347/97

(57) ABSTRACT

An ink circulation device including an ink tank containing ink to be supplied to a printhead, a first chamber installed within an ink circulation path between the printhead and the ink tank to allow the ink to pass from the ink tank to the printhead, and a second chamber divided from the first chamber by a gas permeation membrane and including a gas discharge hole.

### CROSS-REFERENCE TO RELATED APPLICATIONS

This application claims priority under 35 U.S.C. §119(a) from Korean Patent Application No. 10-2005-0082436, filed on Sep. 5, 2005, in the Korean Intellectual Property Office, the disclosure of which is incorporated herein in its entirety by reference.

### BACKGROUND OF THE INVENTION

1. Field of the Invention

The present general inventive concept relates to an ink circulation device of an inkjet image forming apparatus, and more particularly, to an ink circulation device of an inkjet image forming apparatus to remove gases from ink by circulating the ink between an ink tank and a printhead.

2. Description of the Related Art

Ink contains bubbles including air bubbles and a small number of other bubbles generated from the ink itself. The bubbles expand depending on a temperature change (particularly, from low to high temperature) and a pressure change (particularly, from high to lower pressure) of the ink. If there is no device that discharges the expanded bubbles or absorbs the increased volume caused by the bubble expansion, the ink leaks through nozzles of a printhead. The leaked ink contaminates paper or directs the ink ejected through the nozzles to an undesired direction during printing. The ink can be sucked through the nozzles to eliminate the bubbles from the ink. However, in this case, a large amount of the ink is wasted.

As an alternative way to eliminate the bubbles from the ink, the ink is continuously circulated to eliminate the bubbles. FIG. 1 is a view illustrating a conventional ink circulation device, in which ink is continuously circulated between an ink tank 1 and a printhead 2 to discharge gases contained in the ink. Referring to FIG. 1, a circulation pump (P) continuously circulates the ink between the ink tank 1 and the printhead 2. The ink is supplied to the printhead 2 from the ink tank 1, and then the ink is returned to the ink tank 1 through the circulation pump (P) and an ink entrance 3 formed on a bottom of the ink tank 1. Here, the ink contained in the ink circulation path including the printhead 2 is directed to the ink tank 1 by the circulation. Then, gases contained in the ink move up to an upper portion of the ink tank 1 since the gases are lighter than the ink, and the moved up gases are discharged to the outside through a discharge hole 4.

According to the conventional ink circulation device, bubbles can be removed from the ink. However, gases dissolved in the ink or bubbles having a tiny size are not removed from the ink. Further, since the ink tank 1 communicates with the ambient air through the discharge hole 4, the outside air can be continuously mixed with the ink to lower a degassing efficiency.

### SUMMARY OF THE INVENTION

The present general inventive concept provides an ink circulation device of an inkjet image forming apparatus to effectively remove bubbles and dissolved gases from ink.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink circulation device of an inkjet image forming apparatus, including an ink tank containing ink to be supplied to a printhead of the inkjet image forming apparatus, a first chamber installed within an ink circulation path between the printhead and the ink tank to allow the ink to pass from the ink tank to the printhead, and a second chamber divided from the first chamber by a gas permeation membrane, the second chamber including a gas discharge hole.

The ink tank may include a gas blocking membrane. The gas blocking membrane may be a film including at least one of nylon, TEFLON®, polyethylene, and polypropylene. The gas blocking membrane may be a film obtained by coating the ink tank with a metal and at least one of nylon, TEFLON®, polyethylene, and polypropylene.

The gas permeation membrane may be a woven textile film including at least one of polytetrafluoroethylene, TEFLON®, nylon, and polyester, or the gas permeation membrane may be a vacuum foamed film including a poly(phenylenesulfide) material.

The first chamber may be installed within a return path of the ink circulation path through which the ink is returned to the ink tank from the printhead. The ink circulation device may further include an ink pump to pump the ink contained in the first chamber to force the ink to flow in a vicinity of the gas permeation membrane.

The ink circulation device may further include a multi-head pump that includes a first pumping head to pump the ink contained in the first chamber to force the ink to flow in a vicinity of the gas permeation membrane, and a second pumping head connected to the discharge hole of the second chamber to form a negative pressure in the second chamber.

The negative pressure may range from about −200 mm Hg to about −760 mm Hg.

The foregoing and/or other aspects and utilities of the present general inventive concept may also be achieved by providing an ink circulating device useable with an image forming apparatus having a printhead, the device including an ink tank to contain de-gassed ink to be supplied to the printhead, and a separation unit to remove gas from ink provided from the printhead, the separation unit including a first chamber to receive the ink from the printhead and to provide the de-gassed ink to the ink tank, a second chamber to discharge the gas removed from the ink to an outside of the ink circulating device, and a gas permeable membrane separating the first and second chambers to remove the gas from the ink.

The ink tank may be impermeable to gas. The ink tank may include a gas impermeable membrane to prevent gas outside of the ink tank from entering the ink tank.

The ink circulating device may further include a first pump to pump the ink in the first chamber towards the gas permeable membrane and to pump the de-gassed ink towards the ink tank, and a second pump to create a negative pressure in the second chamber to draw the ink in the first chamber towards the gas permeable membrane, to draw the gas from the ink across the gas permeable membrane, and/or to pump the gas removed from the ink to the outside of the ink circulating device. The negative pressure may be greater than or equal to −706 mm Hg.

The first chamber may include an inlet connected to the printhead to receive the ink from the printhead, and an outlet connected to the ink tank to provide the de-gassed ink to the ink tank, The second chamber may include a discharge opening to discharge the gas removed from the ink to the outside of the ink circulating device.

The ink circulating device may further include a multi-head pump to pump the de-gassed ink towards the ink tank, and to pump the gas removed from the ink to the outside of the ink circulating device. The multi-head pump may include an ink chamber to receiving the de-gassed ink from the first chamber and to discharge the de-gassed ink to the ink tank, and a gas chamber to receive the gas removed from the ink from the second chamber and to discharge the gas removed from the ink to the outside of the ink circulating device.

The ink chamber may include a first ink sub-chamber including a first valve to discharge the de-gassed ink to the ink tank, a second ink sub-chamber including a second valve to receive the de-gassed ink from the first chamber, and a third ink sub-chamber including an ink pumping unit and a first elastic member to generate pressure changes in the first and second ink sub-chambers, and the gas chamber may include a first gas sub-chamber including a third valve to receive the gas removed from the ink from the second chamber, a second gas sub-chamber including a fourth valve to discharge the gas removed from the ink to the outside of the ink circulating device, and a third ink sub-chamber including a gas pumping unit and a second elastic member to generate pressure changes in the first and second gas sub-chambers.

The ink circulating device may further include an actuator to move the ink pumping unit and the gas pumping unit to generate the pressure changes in the first and second ink chambers and the first and second gas chambers, respectively. The actuator may include a rotatable cam having a protrusion, and a piston to contact the rotatable cam, and the piston may the ink and gas pumping units in a first direction when the piston contacts the protrusion of the rotatable cam, and the piston may allow the first and second elastic members to move the ink and gas pumping units, respectively, in a second direction when the piston contacts a portion of the rotatable cam other than the protrusion.

The foregoing and/or other aspects and utilities of the present general inventive concept may also be achieved by providing an image forming apparatus, including a printhead to eject de-gassed ink onto a printing medium, an ink tank to contain de-gassed ink to be supplied to the printhead, an ink supply path connecting the printhead and the ink tank, and a separation unit located along the supply path between the printhead and the ink tank to remove gas from ink provided from the printhead, the separation unit including a first chamber to receive the ink from the printhead and to provide the de-gassed ink to the ink tank, a second chamber to discharge the gas removed from the ink to an outside of the ink circulating device, and a gas permeable membrane separating the first and second chambers to remove the gas from the ink.

The foregoing and/or other aspects and utilities of the present general inventive concept may also be achieved by providing a method of circulating ink in an image forming apparatus including a printhead, an ink tank, and a separation unit having first and second chambers separated by a gas permeable membrane, the method including receiving ink in the first chamber of the separation unit from the printhead, separating gas from the ink in the first chamber to form de-gassed ink and passing the gas through the gas permeable membrane into the second chamber, discharging the gas from the second chamber to outside of the image forming apparatus, providing the de-gassed ink to the ink tank, and providing the de-gassed ink from the ink tank to the printhead.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a structure of a conventional ink circulation device;

FIG. 2 is a view illustrating a structure of an ink circulation device, according to an embodiment of the present general inventive concept;

FIG. 3 is a sectional view illustrating a first chamber and a second chamber of the ink circulation device of FIG. 2, according to an embodiment of the present general inventive concept;

FIG. 4 is a view illustrating a structure of an ink circulation device, according to another embodiment of the present general inventive concept;

FIG. 5 is a view illustrating an exemplary structure of a multi-head pump of the ink circulation device FIG. 4; and

FIG. 6 is a view illustrating an operation of a multi-head pump of the ink circulation device of FIG. 4, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 is a view illustrating a structure of an ink circulation device, according to an embodiment of the present general inventive concept. Specifically, FIG. 2 illustrates a printhead 10 to eject ink and an ink tank 20 in which the ink is contained. The ink is circulated between the printhead 10 and the ink tank 20 along an ink circulation path 30 including a supply path 31 and a return path 32.

The printhead 10 includes a plurality of nozzles (not illustrated) to eject the ink, and includes a chamber and a manifold (not illustrated). The chamber communicates with the nozzles and includes an ejecting unit (e.g., a piezoelectric unit or a heater) (not illustrated) to generate pressure to eject the ink. The manifold supplies ink to the chamber. Since the chamber, the ejecting unit, and the manifold are well known to those of ordinary skill in the art, detail descriptions thereof will be omitted. The printhead 10 may further include a negative pressure regulator (NPR, not illustrated). When printing is not being carried out, the NPR generates a negative pressure to prevent the ink from leaking through the nozzles of the printhead 10.

The ink tank 20 includes a gas blocking membrane 21. The gas blocking membrane 21 may be a flexible film formed of a high molecular substance, such as at least one of nylon, TEFLON®, PE (polyethylene), and PP (polypropylene), so that external gas (external to the ink tank 20) can be prevented from entering the ink tank 20 due to a gas diffusion effect resulting from a pressure difference between an outside and an inside of the membrane 21. Further, metal, such as aluminum, can be coated on the above-mentioned flexible film. The ink tank 20 may be a flexible bag having the gas blocking membrane 21.

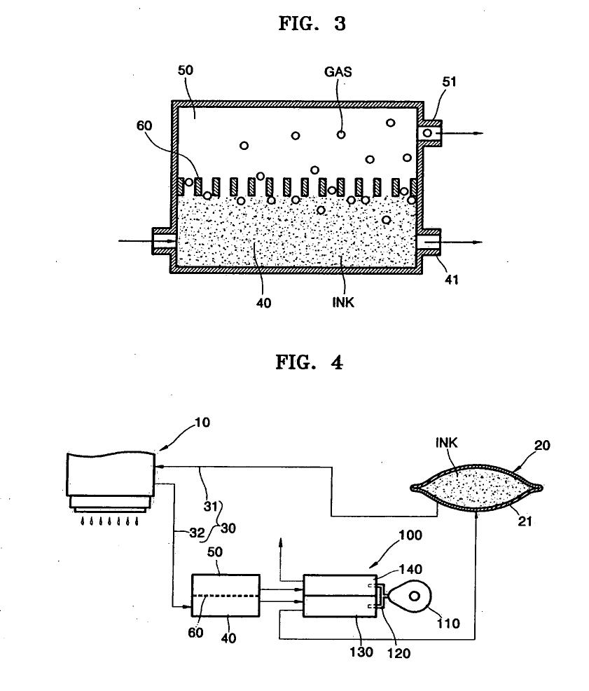

Within the ink circulation path 30, a first chamber 40 is installed to allow the ink to pass therethrough. As illustrated in FIG. 3, a second chamber 50 is divided from the first chamber 40 by a gas permeation membrane 60. The second chamber 50 is provided with a gas discharge hole 51 to discharge gas. The gas permeation membrane 60 allows gas to pass therethrough, but it does not allow liquid to pass therethrough. The gas permeation membrane 60 may be a woven textile film formed of at least one of PTFE (polytetrafluoroethylene), TEFLON®, nylon, and polyester, or the gas permeation membrane 60 may be a vacuum foamed film formed of a PPS (poly(phenylenesulfide)) material. For example, GORETEX® can be used in the gas permeation membrane 60.

According to the above-mentioned structure, the ink contained in the ink tank 20 is circulated through the supply path 31, the printhead 10, the return path 32, and the first chamber 40, and then the ink is returned to the ink tank 10 through an outlet 41 in the first chamber 40. While the ink passes through the first chamber 40, gases contained in the ink moves up towards the gas permeation membrane 60 because the gases are lighter than the ink. The moved-up gases enter the second chamber 50 through the gas permeation membrane 60, and then the gases are discharged to outside of the second chamber 50 through the gas discharge hole 51. Meanwhile, the de-gassed ink is directed from the first chamber 40 through the outlet 41 and to the ink tank 20. The gases can be continuously removed from the ink by repeatedly circulating the ink along the above-mentioned path.

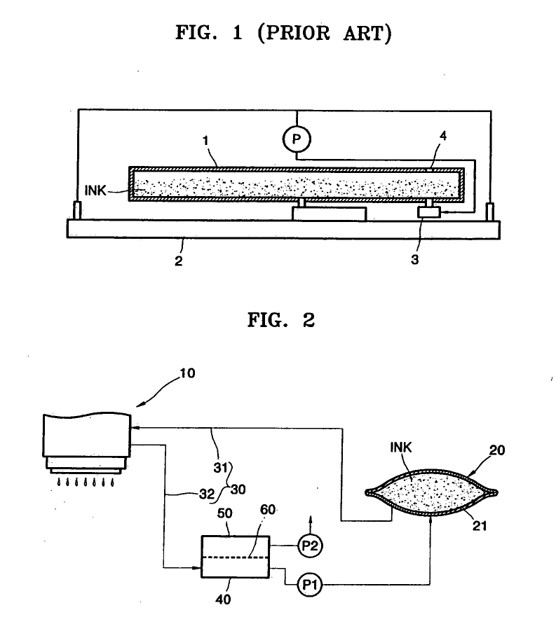

Further, as described above, since the ink tank 20 is provided with the gas blocking membrane 21, outside gases cannot be mixed into the ink through the ink tank 20. Moreover, as compared to an amount of gas mixing into the ink at the ink tank 1 due to a communication of the ink tank 1 with air outside of the conventional ink circulation device illustrated in FIG. 1, an amount of gas mixing into the ink through the nozzles of the printhead 10 according to the present embodiment is very small. Furthermore, since the first and second chambers 40 and 50 are not required to have a large size, an amount of gas that reversely passes through the gas permeation membrane 60 to mix with the ink in the first chamber 40 is much smaller than an amount of the gas that passes through the gas permeation membrane 60 to the second chamber 50. Therefore, according to this embodiment of the present general inventive concept, an amount of the gas mixed in the ink becomes smaller and smaller as the ink is circulated.

While the ink is being ejected from the printhead 10, a temperature of the ink increases, and this temperature increase can cause the gas dissolved in the ink to create bubbles. Further, outside air can be introduced through the nozzles of the printhead 10. If these bubbles and air travel back to the printhead 10 with the ink, ink rejection errors can occur. Therefore, according to this embodiment of the present general inventive concept, the first and second chambers 40 and 50 are located within the return path 32 of the ink to remove the gases from the ink returning to the ink tank 20, so that the gases can be effectively removed from the ink.

Referring again to FIG. 2, the ink circulation device may further include an ink pump P1 to pump the ink in the first chamber 40 so that the ink flows along the gas permeation membrane 60. With this structure, an amount of the ink flowing along the gas permeation membrane 60 can be increased, thereby removing the gases from the ink more effectively. Further, since the ink flows along the surface of the gas permeation membrane 60, molecules of the gases are more active. Therefore, the gases can move to the second chamber 50 through the gas permeation membrane 60 more easily.

As illustrated in FIG. 2, the ink circulation device may further include an exhaust pump P2 to generate a negative pressure in the second chamber 50. The exhaust pump P2 is connected with the gas discharge hole 51 to discharge the gases to the outside and to apply a negative pressure to the second chamber 50. As a result, the gases in the ink can be more effectively moved to the second chamber 50 through the gas permeation membrane 60 due to a pressure difference between the first and second chambers 40 and 50 resulting from the negative pressure applied to the second chamber 50. The negative pressure may range from, for example, about −200 mm Hg to about =760 mm Hg. If the negative pressure is lower than −760 mmHg, the ink circulation may be undesirably burdened. By applying the negative pressure to the second chamber 50 in this way, even small bubbles can be easily removed.

FIG. 4 is a view illustrating a structure of an ink circulation device, according to another embodiment of the present general inventive concept. Referring to FIG. 4, the ink circulation device of this embodiment employs a multi-head pump 100 instead of the ink pump P1 and the exhaust pump P2 of FIG. 1. Referring to FIGS. 4 and 5, the multi-head pump 100 may include a first pumping head 130 and a second pumping head 140. The first pumping head 130 pumps the ink contained in a first chamber 40 to form an ink circulation in the vicinity of (e.g., near to or flowing along) a gas permeation membrane 60, and the second pumping head 140 is connected with a gas discharge hole 51 of a second chamber 50 to apply a negative pressure to the second chamber 50.

Referring to FIG. 5, the first pumping head 130 includes an ink chamber 133 having an intake 131 and an outlet 132. The intake 131 is connected to the first chamber 40. The intake 131 and the outlet 132 include a first ink valve 134a and a second ink value 134b, respectively. Elastic members, such as springs 136a and 136b, interact with the first and second valves 134a and 134b, respectively, to urge the first and second ink valves 134a and 134b toward the intake 131 and the outlet 132, respectively. The first and second ink valves 134a and 134b may operate in opposite directions. An ink pumping plate 135 is installed in the ink chamber 133. An elastic member, such as a spring 137, provides an elastic force to the ink pumping plate 135 in a direction to increase a volume of the ink chamber 133.

Referring to FIG. 5, the second pumping head 140 includes a gas chamber 143 having an intake 141 and an outlet 142. The intake 141 is connected to the gas discharge hole 51 of the second chamber 50. The intake 141 and the outlet 142 include a first gas valve 144a and a second gas value 144b, respectively. Springs 146a and 146b interact with the first and second gas valves 144a and 144b, respectively, to urge the first and second gas valves 144a and 144b toward the intake 141 and the outlet 142, respectively. The first and second gas valves 144a and 144b may operate in opposite directions. A gas pumping plate 145 is installed in the gas chamber 143. An elastic member, such as a spring 147, provides an elastic force to the gas pumping plate 145 in a direction to increase a volume of the gas chamber 143.

When a cam 110 is rotated by a driving unit (not illustrated), a piston 120 pushes the ink pumping plate 135 and the gas pumping plate 145.

As illustrated in FIG. 5, when a top dead center (H) of the cam 110 pushes the piston 120, the ink pumping plate 135 and the gas pumping plate 145 are moved in the direction of (A). Upon the movement of the gas pumping plate 145 in the direction of (A), the gas in the gas chamber 143 is compressed, and the intake 141 is closed by the first gas valve 144a and the outlet 142 is opened by the second gas valve 144b. Therefore, the gas can be discharged to outside of the ink circulation device through the outlet 142. Since the intake 141 is closed, the pressure of the gas chamber 143 does not affect the pressure of the second chamber 50.

Meanwhile, upon the movement of the ink pumping plate 135 in the direction of (A), the ink in the ink chamber 133 is also compressed, and the intake 131 is closed by the first ink valve 134a and the outlet 132 is opened by the second ink valve 134b. Therefore, the ink can be returned to the ink tank 20 through the outlet 132. Since the intake 131 is closed, the ink does not reversely flow from the ink chamber 133 to the first chamber 40.

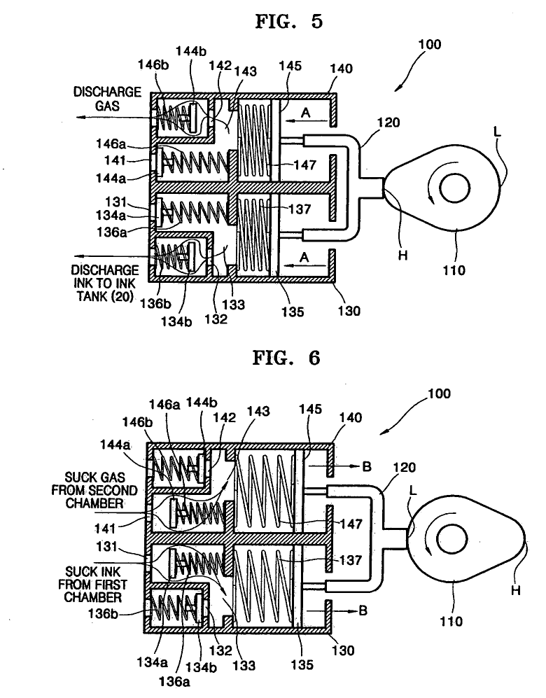

As illustrated in FIG. 6, when the cam 110 rotates to push the piston 120 at a bottom dead center (L) of the cam 110, the ink pumping plate 135 and the gas pumping plate 145 are moved in the direction of (B) by the elastic force of the springs 137 and 147. Upon the movement of the gas pumping plate 145 in the direction of (B), the volume of the gas chamber 143 increases to generate a negative pressure in the gas chamber 143. Due to the negative pressure, the first gas valve 144a opens the intake 141 to communicate the gas chamber 143 with the second chamber 50. Therefore, the gas in the second chamber 50 is drawn to the gas chamber 143 through the intake 141 by the negative pressure of the gas chamber 143. The negative pressure and the elastic force of the spring 146b cause the second gas valve 144b to close the outlet 142. Therefore, a reverse flow of gas outside of the ink circulation device into the gas chamber 143 can be prevented.

Meanwhile, upon the movement of the ink pumping plate 135 in the direction of (B), the volume of the ink chamber 133 increases to generate a negative pressure in the ink chamber 133. This negative pressure causes the first ink valve 134a to move away from the intake 131, thereby opening the intake 131 to communicate the ink chamber 133 with the first chamber 40, and thus the first chamber 40 is affected by the negative pressure. Therefore, the ink contained in the first chamber 40 is sucked into the ink chamber 133 through the intake 131. The negative pressure and the elastic force of the spring 136b cause the second ink valve 134b to close the outlet 132. Since the negative pressure in the ink chamber 133 is only used to suck the ink from the first chamber 40, an effective ink flow can be induced in the first chamber 40.

The ink circulation device of the present general inventive concept can be used in a shuttle type inkjet image forming apparatus that forms an image by ejecting ink onto a printing medium while moving a printhead thereof in a perpendicular direction (a main scanning direction) to a feeding direction of the printing medium (a subsidiary scanning direction). Further, the ink circulation device of the present general inventive concept can be used in an array type inkjet image forming apparatus that employs a printhead having a main scanning direction length corresponding to a width of a printing medium. Since the printhead of the array type inkjet image forming apparatus has many nozzles, a large amount of ink is wasted when the ink is forcibly sucked through the nozzles to remove gases from the ink according to a conventional suction type de-gassing method. Therefore, ink circulation devices according to embodiments of the present general inventive concept are more suitable for the array type inkjet image forming apparatus.

Ink circulation devices according to various embodiments of present general inventive concept provide at least the following advantageous effects. The ink circulation devices may employ a gas permeation membrane, so that gases contained in ink can be easily removed. The ink circulation devices may employ a tank having a gas blocking membrane, so that gases contained in ink can be removed almost completely by circulating the ink. The ink circulation devices can make ink flow along a gas permeation membrane to increase a contact between the ink and the gas permeation membrane, so gases contained in the ink can be more effectively removed. Small bubbles as well as large bubbles can be removed from ink by forming a negative pressure in a second chamber of the ink circulation devices. The ink circulation devices can have a simple structure by employing a multi-head pump.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink circulation device of an inkjet image forming apparatus, comprising:
an ink tank containing ink to be supplied to a printhead of the inkjet image forming apparatus;
a first chamber installed within an ink circulation path between the printhead and the ink tank to allow the ink to pass from the ink tank to the printhead; and
a second chamber divided from the first chamber by a gas permeation membrane, the second chamber including a gas discharge hole.

2. The ink circulation device of claim 1, wherein the ink tank includes a gas blocking membrane.

3. The ink circulation device of claim 2, wherein the gas blocking membrane is a film including at least one of nylon, TEFLON®, polyethylene, and polypropylene.

4. The ink circulation device of claim 2, wherein the gas blocking membrane is a film obtained by coating the ink tank with a metal and at least one of nylon, TEFLON®, polyethylene, and polypropylene.

5. The ink circulation device of claim 1, wherein the gas permeation membrane is a woven textile film including at least one of polytetrafluoroethylene, TEFLON®, nylon, and polyester, or the gas permeation membrane is a vacuum foamed film including a poly(phenylenesulfide) material.

6. The ink circulation device of claim 1, wherein the first chamber is installed within a return path of the ink circulation path through which the ink is returned to the ink tank from the printhead.

7. The ink circulation device of claim 1, further comprising:
an ink pump to pump the ink contained in the first chamber to force the ink to flow in a vicinity of the gas permeation membrane.

8. The ink circulation device of claim 1, further comprising:
an exhaust pump connected to the discharge hole of the second chamber to form a negative pressure in the second chamber.

9. The ink circulation device of claim 8, wherein the negative pressure ranges from about −200 mm Hg to about −760 mm Hg.

10. The ink circulation device of claim 1, further comprising:
a multi-head pump that includes a first pumping head to pump the ink contained in the first chamber to force the ink to flow in a vicinity of the gas permeation membrane, and a second pumping head connected to the discharge hole of the second chamber to form a negative pressure in the second chamber.

11. The ink circulation device of claim 10, wherein the ink tank includes a gas blocking membrane.

12. The ink circulation device of claim 10, wherein the negative pressure ranges from about −200 mmHg to about −760 mmHg.

13. The ink circulation device of claim 1, further comprising:
an ink pump to pump the ink contained in the first chamber to force the ink to flow in a vicinity of the gas permeation membrane; and
an exhaust pump connected to the discharge hole of the second chamber to form a negative pressure in the second chamber,
wherein the ink tank includes a gas blocking membrane.

14. An ink circulating device useable with an image forming apparatus having a printhead, the device comprising:
an ink tank to contain de-gassed ink to be supplied to the printhead; and
a separation unit to remove gas from ink provided from the printhead, the separation unit comprising:
a first chamber to receive the ink from the printhead and to provide the de-gassed ink to the ink tank,
a second chamber to discharge the gas removed from the ink to an outside of the ink circulating device, and
a gas permeable membrane separating the first and second chambers to remove the gas from the ink.

15. The ink circulating device of claim 14, wherein the ink tank is impermeable to gas.

16. The ink circulating device of claim 14, wherein the ink tank comprises:
a gas impermeable membrane to prevent gas outside of the ink tank from entering the ink tank.

17. The ink circulating device of claim 14, further comprising:
a first pump to pump the ink in the first chamber towards the gas permeable membrane, and to pump the de-gassed ink towards the ink tank; and
a second pump to create a negative pressure in the second chamber to draw the ink in the first chamber towards the gas permeable membrane, to draw the gas from the ink across the gas permeable membrane, and/or to pump the gas removed from the ink to the outside of the ink circulating device.

18. The ink circulating device of claim 17, where the negative pressure is greater than or equal to −706 mm Hg.

19. The ink circulating device of claim 14, wherein the first chamber comprises:
an inlet connected to the printhead to receive the ink from the printhead; and
an outlet connected to the ink tank to provide the de-gassed ink to the ink tank,

20. The ink circulating device of claim 14, wherein the second chamber comprises:
a discharge opening to discharge the gas removed from the ink to the outside of the ink circulating device.

21. The ink circulating device of claim 14, further comprising:
a multi-head pump to pump the de-gassed ink towards the ink tank, and to pump the gas removed from the ink to the outside of the ink circulating device.

22. The ink circulating device of claim 21, wherein the multi-head pump comprises:
an ink chamber to receiving the de-gassed ink from the first chamber and to discharge the de-gassed ink to the ink tank; and
a gas chamber to receive the gas removed from the ink from the second chamber and to discharge the gas removed from the ink to the outside of the ink circulating device.

23. The ink circulating device of claim 22, wherein:
the ink chamber comprises a first ink sub-chamber including a first valve to discharge the de-gassed ink to the ink tank, a second ink sub-chamber including a second valve to receive the de-gassed ink from the first chamber, and a third ink sub-chamber including an ink pumping unit and a first elastic member to generate pressure changes in the first and second ink sub-chambers; and
the gas chamber comprises a first gas sub-chamber including a third valve to receive the gas removed from the ink from the second chamber, a second gas sub-chamber including a fourth valve to discharge the gas removed from the ink to the outside of the ink circulating device, and a third ink sub-chamber including a gas pumping unit and a second elastic member to generate pressure changes in the first and second gas sub-chambers.

24. The ink circulating device of claim 23, further comprising:
an actuator to move the ink pumping unit and the gas pumping unit to generate the pressure changes in the first and second ink chambers and the first and second gas chambers, respectively.

25. The ink circulating device of claim 24, wherein the actuator comprises:
a rotatable cam having a protrusion; and
a piston to contact the rotatable cam,
wherein the piston moves the ink and gas pumping units in a first direction when the piston contacts the protrusion of the rotatable cam, and the piston allows the first and second elastic members to move the ink and gas pumping units, respectively, in a second direction when the piston contacts a portion of the rotatable cam other than the protrusion.

26. An image forming apparatus, comprising:
a printhead to eject de-gassed ink onto a printing medium;
an ink tank to contain de-gassed ink to be supplied to the printhead;
an ink supply path connecting the printhead and the ink tank; and
a separation unit located along the supply path between the printhead and the ink tank to remove gas from ink provided from the printhead, the separation unit comprising:
a first chamber to receive the ink from the printhead and to provide the de-gassed ink to the ink tank,
a second chamber to discharge the gas removed from the ink to an outside of the ink circulating device, and
a gas permeable membrane separating the first and second chambers to remove the gas from the ink.

27. A method of circulating ink in an image forming apparatus including a printhead, an ink tank, and a separation unit having first and second chambers separated by a gas permeable membrane, the method comprising:
receiving ink in the first chamber of the separation unit from the printhead;
separating gas from the ink in the first chamber to form de-gassed ink and passing the gas through the gas permeable membrane into the second chamber;
discharging the gas from the second chamber to outside of the image forming apparatus;
providing the de-gassed ink to the ink tank; and
providing the de-gassed ink from the ink tank to the printhead.
